(19) United States
(12) Patent Application Publication
(10) Pub. No.: US 2013/0144627 A1
(43) Pub. Date: Jun. 6, 2013

(54) VOICE CONTROL CIRCUIT FOR STARTING ELECTRONIC DEVICES

(71) Applicant: JIE LI, Shenzhen City (CN)

(72) Inventor: JIE LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/415,852

(22) Filed: Mar. 9, 2012

(30) Foreign Application Priority Data
Dec. 3, 2011 (CN) 201110395472.8

(51) Int. Cl. G10L 15/00

(52) U.S. Cl. 704/270; 704/E15.001

(57) ABSTRACT

A control circuit employed in an electronic device includes a microphone, a level conversion circuit, and a voice processing circuit. The voice processing circuit includes a voice operated switch connected between the microphone and the level conversion circuit. The microphone picks up voice commands, the voice operated switch receives the voice commands from the microphone, and outputs a high voltage signal when a volume of the voice commands is greater than or equal to a predetermined volume threshold or is within a predetermined volume range, the level conversion circuit converts the high voltage signal into a low voltage signal for turning on the electronic device.

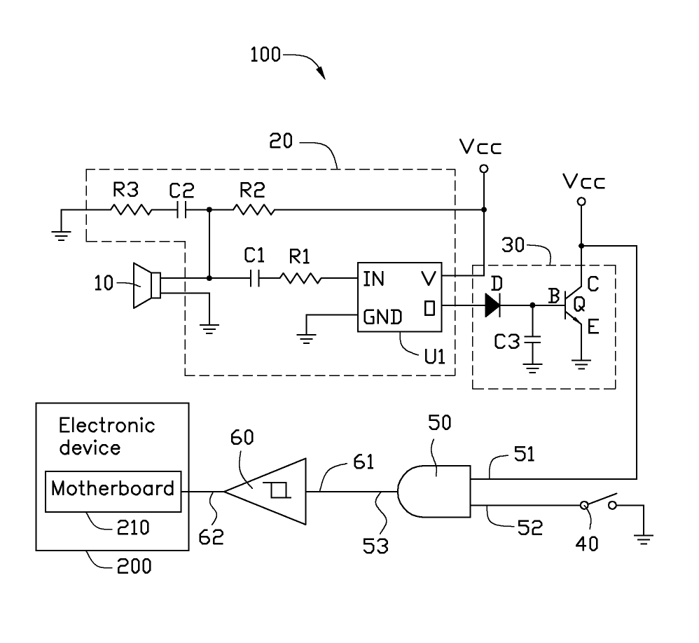

### BACKGROUND

1. Technical Field

The disclosure generally relates to control circuits, particularly to a voice control circuit for starting electronic devices.

2. Description of the Related Art

Computers and servers can be started by turning on a power switch. However, if such electronic devices are located at another location such as a computer room, which is usually far away from an operator in a control room, the operator has to enter the computer room to turn on the power switch to start the electronic devices. This is very inconvenient for the operator.

Therefore, there is room for improvement within the art.

### BRIEF DESCRIPTION OF THE DRAWINGS

Many aspects of an exemplary voice control circuit for starting electronic devices can be better understood with reference to the drawing. The components in the drawing are not necessarily drawn to scale, the emphasis instead being placed upon clearly illustrating the principles of the disclosure.

The FIGURE is a circuit view of a control circuit for turning on electronic devices, according to an exemplary embodiment.

### DETAILED DESCRIPTION

The FIGURE shows a control circuit 100, which can be used in an electronic device 200 such as personal computer, server, or any other like device.

In one exemplary embodiment, the control circuit 100 includes a microphone 10, a voice processing circuit 20, a level conversion circuit 30, a power switch 40, an AND gate 50, and a trigger 60. The voice processing circuit 20, the level conversion circuit 30, the power switch 40, the AND gate 50, and the trigger 60 can be integrated on a motherboard 210 of the electronic device 200.

The microphone 10 is electronically connected to the voice processing circuit 20 via a cable. The microphone 10 picks up voice commands from an operator, and sends the voice commands to the voice processing circuit 20.

The voice processing circuit 20 outputs a high voltage signal according to the voice commands, the high voltage signal may be a digital signal such as logic “1”, or an analog voltage signal of 3V or 5V. The voice processing circuit 20 includes a voice operated switch (VOS) U1, a first capacitor C1, a first resistor R1, a second resistor R2, a third resistor R3, and a second capacitor C2.

The voice operated switch U1 includes a power pin V, a ground pin GND, a voice input pin IN, and a signal output pin O. The power pin V is electronically connected to a power supply VCC. The voice input pin IN is electronically connected to the microphone 10 via the first resistor R1 and the first capacitor C1. The second resistor R2, the second capacitor C2, and the third resistor R3 are electronically connected between the power supply VCC and ground, in series. Moreover, the end of the first capacitor C1 connected to the microphone 10 is electronically connected between the second resistor R2 and the second capacitor C2.

The microphone may pick up environmental noise. In order to prevent accidental starts of the electronic device 200, the voice operated switch U1 can predetermine a volume threshold or a predetermined volume range by adjusting the resistance value of the third resistor R3. Thus, the voice operated switch U1 can be set up to identify the voice commands and the operator from general environmental noise according to the predetermined volume threshold or the predetermined volume range. Specifically, when the volume of a sound is greater than or equal to the volume threshold, the sound will be regarded as a voice command by the voice operated switch U1; when the volume of a sound is lower than the volume threshold, the sound will be regarded as environmental noise. Similarly, when the volume of a sound is within the predetermined volume range, the sound will be regarded as a voice command by the voice operated switch U1; when the volume of a sound is outside the predetermined volume range, the sound will be regarded as environmental noise.

The microphone 10 will output an instantaneous high pulse as a reaction to receiving the voice commands, then the voice operated switch U1 adjusts the instantaneous high pulse, and outputs the high voltage signal via the signal output pin O.

The level conversion circuit 30 inverses the high voltage signal, and outputs a low voltage signal (e.g., logic 0). The level conversion circuit 30 includes a diode D, a third capacitor C3, and a BJT (bipolar junction transistor) Q. An anode of the diode D is electronically connected to the signal output pin O. The BJT Q includes a base B, an emitter E, and a collector C. The base B is connected to a cathode of the diode D, and is connected to ground via the third capacitor C3. The emitter E is connected to ground, and the collector C is connected to the power supply VCC. When the level conversion circuit 30 receives the high voltage signal from the voice processing circuit 20, the diode and the BJT Q are both enabled, and the collector C of the BJT Q then outputs the low voltage signal. Additionally, the diode D can protect the voice operated switch U1 from burnout if the BJT Q should ever break down.

The power switch 40 can be an universal power button of the electronic device 200. When the power switch 40 is turned on, the power switch 40 can output a low voltage signal (e.g., logic 0) equivalent to the low voltage signal described in paragraph above.

The AND gate 50 includes two input terminals 51, 52, and an output terminal 53. The input terminal 51 is electronically connected to the collector C of the BJT Q for receiving the low voltage signal from the BJT Q. The input terminal 52 is electronically connected to the power switch 40, to receive the low voltage signal when the switch 40 is on. When at least one of the two input terminals 51, 52 receives the low voltage signal, the output terminal 53 will output a low voltage signal (e.g., logic 0).

In one exemplary embodiment, the trigger 60 is a schmitt trigger which includes an input pin 61 and an output pin 62. The input pin 61 is electronically connected to the output terminal 53, for receiving the low voltage signal outputted from the AND gate 50. The output pin 62 is electronically connected to the motherboard 210 of the electronic device 200, to transmit the low voltage signal to the motherboard 210.

Thus, the motherboard 210 can receive the low voltage signal, and control the electronic device 200 to turn on.

When the operator in the control room wants to start the electronic device 200 in another place, the operator can speak a command according to the predetermined volume threshold or the predetermined volume range. The microphone 10 picks up the command and outputs an instantaneous high pulse, then the voice operated switch U1 outputs the high voltage signal to the level conversion circuit 30 to enable the BJT Q.

The collector C of the BJT Q outputs the low voltage signal to the AND gate 50, and the AND gate 50 outputs the low voltage signal to the motherboard 210 of the electronic device 200 via the trigger 60. In this way, a very convenient startup of the electronic device 200 can be achieved.

Additionally, users can enter the computer room to turn on the electronic device 200 manually by means of the power switch 40.

In other embodiments, the power switch 40, the AND gate 50, and the trigger 60 are not fundamental to the disclosure. The low voltage signal outputted from the level conversion circuit 30 can be directly transmitted to the motherboard 210.

In other embodiments, the BJT Q can be replaced by any other apparatus which can convert a high voltage signal into a low voltage signal, such as a N-channel metal oxide semiconductor field effect transistor (MOSFET).

The control circuit 100 can pick up vocal sounds through the microphone 10, and subject to identification and isolation of vocal commands, the level conversion circuit 30 outputs the low voltage signal to achieve the switching on of the device. The control circuit 100 is both convenient and efficient.

Although numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A control circuit for an electronic device, the control circuit comprising:
a microphone operable to pick up voice commands from an operator;
a level conversion circuit; and
a voice processing circuit comprising a voice operated switch, the voice operated switch electronically connected between the microphone and the level conversion circuit;
wherein the voice operated switch receives the voice commands from the microphone, and outputs a high voltage signal when a volume of the voice commands is greater than or equal to a predetermined volume threshold or is within a predetermined volume range, the level conversion circuit converts the high voltage signal into a low voltage signal for turning on the electronic device.

2. The control circuit as claimed in claim 1, wherein the voice operated switch includes a voice input pin and a signal output pin, the voice input pin is electronically connected to the microphone, and the signal output pin is electronically connected to the level conversion circuit.

3. The control circuit as claimed in claim 2, wherein the voice processing circuit further includes a first resistor and a first capacitor, the first resistor and the first capacitor are electronically connected between the voice input pin and the microphone in series.

4. The control circuit as claimed in claim 3, wherein the voice processing circuit further includes a second resistor, a third resistor, and a second capacitor, the second resistor, the second capacitor, and the third resistor are electronically connected between a power supply and ground in series.

5. The control circuit as claimed in claim 4, wherein one end of the first capacitor connected to the microphone is electronically connected between the second resistor and the second capacitor.

6. The control circuit as claimed in claim 4, wherein the volume threshold or the volume range of the voice operated switch is determined by a resistance value of the third resistor.

7. The control circuit as claimed in claim 1, wherein the voice operated switch identifies the voice commands and general environmental noise according to the predetermined volume threshold or the predetermined volume range.

8. The control circuit as claimed in claim 2, wherein the level conversion circuit includes a diode and a third capacitor, an anode of the diode is electronically connected to the signal output pin, and a cathode of the diode is connected to ground via the third capacitor.

9. The control circuit as claimed in claim 8, wherein the level conversion circuit includes a BJT (bipolar junction transistor), the BJT includes a base, an emitter, and a collector, the base is connected to a cathode of the diode, the emitter is connected to ground, and the collector outputs the low voltage signal.

10. The control circuit as claimed in claim 9, further comprising a power switch and an AND gate, the AND gate includes two input terminals and an output terminal, one of the input terminals is electronically connected to the collector of the BJT, and the other input terminal is electronically connected to the power switch.

11. The control circuit as claimed in claim 10, further comprising a trigger, the trigger includes an input pin and an output pin, the input pin is electronically connected to the output terminal of the AND gate, and the output pin is electronically connected to a motherboard of the electronic device.

12. The control circuit as claimed in claim 11, wherein the trigger is a schmitt trigger.
